(19) United States
(12) Patent Application Publication
(10) Pub. No.: US 2008/0007446 A1
(43) Pub. Date: Jan. 10, 2008

(54) Radar device

(75) Inventor: Mitsuo Nakamura, Nagoya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/820,225

(22) Filed: Jun. 18, 2007

(30) Foreign Application Priority Data
Jul. 4, 2006 (JP) 2006-184806

(51) Int. Cl. G01S 13/00

(52) U.S. Cl. 342/27

(57) ABSTRACT

A laser light is radiated to be reflected by objects, and signals indicative of the reflected light are integrated by an integration processing unit. A state machine unit determines in which states of the waveform of an integrated signal the points are present representing the signal components at regular intervals of the integrated signals, and determines a point series of a plurality of points that follow a particular state transition to be a group that forms a peak waveform representing the reception of a waveform reflected by a reflecting object. A distance calculation unit picks up the integrated signal of the point series that belongs to the group that forms the peak waveform, and calculates the distance to the reflecting object.

### CROSS REFERENCE TO RELATED APPLICATION

This application is based on and incorporates herein by reference Japanese Patent Application No. 2006-184806 filed on Jul. 4, 2006.

### FIELD OF THE INVENTION

This invention relates to a radar device which radiates a plurality of transmission waves within a predetermined angular range, and detects reflecting objects based on the signal waveforms of reflected waves when the reflected waves are received in response to the transmitted signals. This radar device is mounted on, for example, a vehicle and is preferably used for detecting preceding vehicles or obstacles as the reflecting objects.

### BACKGROUND OF THE INVENTION

A conventional radar device has a fine angular resolution by effecting a processing for intergrating (adding up) the received signals over a predetermined range of integration for each of the received signals making it possible to increase the distance of detection yet improving the SN ratio and maintaining a fine angular resolution (for example, US 2004/0169840 corresponding to JP 2004/177350A, and US 2005/0200833 corresponding to JP 2005-257405A).

According to these radar devices, the distance of detection is increased by scanning a laser beam and by integrating the received signals of neighboring angles over a predetermined angular range. Here, the integration processing is realized by adding up the received signals that are subjected to the analog-digital (AD) conversion at discrete points corresponding to a sampling frequency.

The received signals that are to be integrated by the integration processing are the signals (reflection peaks) reflected from the object on which noise components are superposed. The noise components basically generate in a random fashion. The noise components often contain clock pulses of a CPU in the radar device and regular noise components that are affected by the electromagnetic wave noise caused by the emission of a laser beam.

The regular noise components become more remarkable and random noises extinguish, as the averaging processing (integration processing) is repeated. The regular noise components are always contained in integrated signals. The regular noise components are background noise.

The background noise can be obtained by integrating the received signals in a state where no reflecting object is present in the range of radiating the laser beam. Upon effecting the integration processing in a state where there is no reflecting object, the noise component is calculated emphasizing regular noises. By removing the background noise obtained by the integration processing from the result of integrating the received signals in a state where a reflecting object is present (differential processing), the regular noise components can be reliably removed from the integrated signals to take out the reflected signals (peak waveforms of the reflecting object). The waveform of the regular background noise is specific to the circuit configuration of a radar device, and varies depending upon the circuit configuration.

US 2005/0200833 shows in its FIG. 12 a peak waveform obtained by taking a difference between the result (integrated signal) of integrating the received signals in a state where a reflecting object is present and the result (reference noise value or background noise) of integrating the received signals in a state where no reflecting object is present.

Points of the integrated signals and of the reference noise value on a graph shown in its FIG. 12 are in agreement with the AD-converted sampling points, and the differential processing is executed by using the AD-converted results. By subtracting the reference noise value from the integrated signal that is shown, a peak waveform (reflected signal) of a reflecting object is obtained on a region surrounded by a circle.

According to the radar device of US 2005/0200833, a peak waveform of the reflecting object is picked up by effecting the above differential processing and, thereafter, a time is measured from the start of emitting light until a peak value generates in the peak waveform as shown in its FIG. 16. The measured time is multiplied by the speed of light, and the result is divided by 2 to obtain a distance to the reflecting object measured by the radar device.

To measure the time until a peak value generates, the radar device of US 2005/0200833 estimates the peak center of the peak waveform from an average time of the rising time T1 and the falling time T2.

When the method of picking up the peak waveform by subtracting the background noise from the integrated signal is employed as is done by the above radar device, however, the following problems arise as described below.

### [Problem 1]

FIG. 23A illustrates a case where the regular noise components included in the integrated signal (result of integrating the received signals) Si have a level in agreement with that of the background noise Sb. In the case of FIG. 23A, a peak waveform can be suitably picked up by the above differential processing. FIG. 23B illustrates a case where the regular noise components included in the result of integrating the received signals have a level which is deviated from that of the background noise. In the case of FIG. 23B, a peak waveform cannot be suitably picked up by the differential processing.

The background noise Sb is a result of integrating the received signals in a state where no reflecting object is present. Usually, therefore, the integrated result of received signals in a state where no reflecting object is present before using the radar device is stored and is used as the background noise. The background noise may be stored as a fixed value in the ROM or may be measured prior to starting the radar measurement and the result thereof may be pre-stored in the RAM and may be used.

FIG. 23B illustrates a case where operation conditions of the circuit in the radar device are varied due to heat or the like, and the level of the result of integrating the received signals is deviated from the state where the background noise was measured. To avoid the deviation in the level, for example, the background noise may be measured at all times even when the radar measurement is being taken, and may be updated at all times. However, the background noise is the result of integrating the received signals in a state where no reflecting object is present. Therefore, the above situation occurs only probabilistically for the vehicle radar device used being mounted on the vehicle, and it is not possible to measure the background noise at all times.

When the traffic is jamming, for example, preceding vehicles are continuously present in front of the radar device at all times, and the situation is not for measuring the background noise. When usually traveling, further, the preceding vehicles are present in front of the vehicle or reflecting objects other than the vehicles are present on the road, and it seldom happens that there is quite no reflecting object.

### [Problem 2]

FIG. 24 illustrates the result of integrating the received signals having two pieces attached thereto and the background noise. The above result of integrating the received signals is often obtained when two reflecting objects are present in line in a range where the laser beam is radiated. When the background noise is subtracted from result of integrating the received signals, there remains a peak waveform of the initial shape with two peaks attached thereto as shown in FIG. 25. In the differential processing of FIG. 25, the portion where the result of integrating the received signals becomes smaller than the background noise does not assume a negative value but is set to be zero.

To estimate the position of peak center from the peak waveform having such two peaks attached thereto, the radar device of the above patent document, first, so determines that a range in excess of a noise cut line is a peak range which is a mass of one peak. The noise cut line is a line for distinguishing random noise from the true peak waveform when the intensity of the peak waveform becomes small, and is a threshold value for so determining that a signal of an intensity in excess of the above line is a true reflection signal that is not noise.

The random noise remains even after the background noise is subtracted from the result of integrating the received signals. This is because, the random noise is contained in the received signals irrespective of the background noise.

In the case of the peak waveform with two peaks attached thereto as shown in FIG. 25, the radar device of the above patent document that detects the boundary (both ends) of the peak waveform at the noise cut line regards the whole waveform over the peak range of FIG. 25 as a mass of (single) peak waveform.

The above radar device detects a maximum intensity of the peak waveform regarded to be a mass, and sets a detected threshold value calculated by multiplying the maximum intensity by a coefficient k(0<k<1) on the peak waveform. Here, times T1 and T2 at which the detected threshold value intersects the peak waveform are calculated, and an average time of the time T1 and of the falling time T2 is regarded to be an estimated value of the peak center.

In this case, since two peaks have been attached, the estimated peak center is an average of two peaks. Therefore, the position shown in FIG. 25 is regarded to be the position of peak center. When the above peak waveform is obtained with two reflecting objects in line, therefore, the distance calculated by the laser device becomes an average distance of the two object. Namely, even if the two reflecting objects are 10 meters apart from each other, what is calculated is a central distance thereof deviated by about 5 meters from the respective objects. A deviation of about 5 meters produced by the radar device having a resolution of several tens of centimeters is unsatisfactory from the standpoint of precision, and it is desired to solve this problem.

### [Problem 3]

In a general radar device, the light-receiving element and the AD converter circuit are AC-coupled together through a capacitor, and the amount of fluctuation (AC component) in the received signals is input to the AD converter circuit. This is because, if the output level of the light-receiving element is directly input to the AD converter circuit, the input range of AD conversion is often exceeded. Therefore, the DC component is cut so that peak signals lie within a range of AD conversion.

In this configuration, however, if a reflection signal of a high intensity is received, there occurs a phenomenon in that the level after the end of peak greatly falls down being affected by the capacitor and the level becomes smaller than the background noise as shown in FIG. 26. If a second reflection signal is received from another object right after the reception of the first reflection signal having the high peak intensity, the level of peak often becomes lower than the background noise as shown in FIG. 26.

In the above differential processing in this case, the second reflection signal in FIG. 26 becomes zero since the level lower than the background noise is set to be zero. That is, the second reflection signal has no peak waveform; i.e., no peak waveform is detected despite the reflecting object is really present.

### SUMMARY OF THE INVENTION

The present invention has an object of providing a radar device which is capable of suitably picking up a peak waveform of a reflecting object.

According to one aspect of the present invention, a peak waveform is directly picked up by determining the shape of waveform of a received signal from radar means instead of picking up the peak waveform by subtracting the background noise that is done by the prior art. Therefore, there do not occur the above three problems inherent in the prior art ([Problem 1] The level of background noise fluctuates; [Problem 2] The peak waveform with a plurality of peaks attached thereto is regarded to be a mass of peak waveform; [Problem 3] When a second reflection signal is received from another object right after the reception of a first reflection signal having a high peak intensity, the peak waveform of the second reflection signal is not detected). Therefore, it is made possible to suitably pick up the peak waveform of the reflecting object.

In the case of a peak waveform of a general shape as shown in FIG. 9, it will be learned that the points representing the signal components at regular intervals forming the peak waveform (sampling points of when the received signals are AD-converted at a predetermined sampling frequency) undergo a particular state transition like “rise start ST2”→“rising ST3”→“falling ST4”→“peak search ST1”.

According to the present invention, attention is given to the fact that a plurality of points that are continuing in time and are forming a peak waveform undergo a state transition. Moreover, state determining means determines in which state of peak search, rise start, rising, falling or rise check, a point that is to be determined is present relying upon a point that is to be determined, upon the signs of differences of at least two points preceding and succeeding in time the above point and upon the magnitudes of the differences.

Among the points determined by the state determining means, therefore, if a plurality of points continuing in time undergo a particular state transition like, for example, “rise start ST2”→“rising ST3”→“falling ST4”→“peak search ST1”, then the group-determining means determines a point series of a plurality of points continuing in time to be a group that forms a peak waveform.

In a state transition diagram shown in FIG. 11, therefore, if the following five particular state transitions are followed, it can be so determined that a point series of a plurality of points following the state transitions is a group that forms a peak waveform. Here, the following state transitions (a) to (e) are not representing all states in the transition steps but are describing only three states; i.e., “first state”→“last state”→“next of the last state”, and the states on the way are omitted.
(a) “Rise start”→“falling_{—}1”→“peak search”.
(b) “Rise start”→“falling_{—}4”→“peak search”.
(c) “Rise start”→“rise check”→“peak search”.
(d) “Rise start”→“rise check”→“rise start”.
(e) “Rise start”→“rising_{—}3”→“rise start”.

When there is a plurality of groups forming peak waveforms (particularly, having two peaks attached thereto), the boundaries of peak waveforms cannot be clearly discerned from the received signals of point series belonging to the groups. In the case of a waveform synthesizing two peaks as shown in, for example, FIG. 20, data are necessary for clarifying a peak separation point (boundary of peaks).

Accordingly, as shown in FIG. 20, group data (group numbers in FIG. 20) for distinguishing the groups are imparted to all points belong to the groups in a manner to possess the same group numbers in each group. Therefore, even when a plurality of peaks is attached, the boundaries in the peak waveforms become clear, and the peak waveforms can be distinguished.

In FIG. 20, the groups and the group numbers imparted to the points in each group are corresponding in a one-to-one manner. In FIG. 20, further, the points of a group number “0” (zero) are the points that are not picked up as a group for forming a peak waveform. The signal components of these points are zero at all times.

The points other than those having the group number “0” (zero) are the points picked up as a group forming a peak waveform. For example, the four points having a group number “1” belong to a group forming the same peak waveform. The group number “1” is followed by three points of a group number “2” without holding the group number “0” therebetween. This is because the two peaks of the group number “1” and the group number “2” had been attached to each other, and were separated apart into two peaks with a peak separation point as a boundary.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram illustrating a device for controlling a vehicle to which a radar device of the present invention is applied;

FIG. 2 is a block diagram illustrating a laser radar sensor;

FIG. 3 is a block diagram illustrating a detector circuit in the laser radar sensor;

FIG. 4 is a perspective view showing a radiation region of the laser radar sensor;

FIG. 5 is a waveform diagram illustrating digital conversion processing for the received light signals by an AD converter unit in the detector circuit;

FIG. 6 is a diagram schematically illustrating a range of received signals that are to be integrated when a range of the received light signals to be integrated is set to be four;

FIG. 7 is a diagram illustrating processing for integrating a plurality of received light signals;

FIG. 8 is a diagram illustrating a case when a plurality of received light signals are integrated, a degree of amplifying the received light signal components corresponding to the intensity of the reflected light is greater than a degree of amplifying the noise signal components;

FIG. 9 is a diagram illustrating the states (peak search ST1, rise start ST2, rising ST3, falling ST4, rise check ST5) in the waveform of an integrated signal;

FIGS. 10A and 10B are diagrams showing a point that is to be determined (verification point) and two points preceding and succeeding in time the above point, respectively;

FIG. 11 is a diagram of state transitions in determining verification points;

FIG. 12 is a diagram illustrating conditions for a first determination in the diagram of state transitions;

FIG. 13 is a diagram illustrating the conditions for a second determination in the diagram of state transitions;

FIG. 14 is a diagram illustrating the conditions for a third determination in the diagram of state transitions;

FIG. 15 is a diagram illustrating the conditions for a fourth determination in the diagram of state transitions;

FIG. 16 is a diagram illustrating the conditions for a fifth determination in the diagram of state transitions;

FIG. 17 is a diagram illustrating the conditions for sixth determination in the diagram of state transitions;

FIG. 18 is a diagram illustrating the conditions for seventh determination in the diagram of state transitions;

FIGS. 19A and 19B are diagrams illustrating a method of removing an offset component Hs from a signal component PKi of each point belonging to a peak group PK;

FIG. 20 is a diagram illustrating integrated signals after the offset is removed and group numbers;

FIG. 21A is a diagram illustrating a method of picking up peak waveforms from the integrated signals including two pieces which are not attached thereto, and FIG. 21B is a diagram illustrating a method of picking up peak waveforms from the integrated signals including two pieces that are attached thereto;

FIG. 22 is a block diagram illustrating the detector circuit according to a modified embodiment;

FIG. 23A is a diagram illustrating a conventional case where the levels are in agreement between the result of integrating the received signals and the background noise, and FIG. 23B is a diagram illustrating a conventional case where the levels are deviating between the result of integrating the received signals and the background noise;

FIG. 24 is a diagram illustrating the result of integrating the received signals with two pieces attached thereto and the background noise in the conventional case;

FIG. 25 is a diagram illustrating a peak waveform with two peaks attached thereto in the conventional case; and

FIG. 26 is a diagram illustrating a conventional case, in which a second reflection signal having a weak peak intensity is received from another object right after the reception of a first reflection signal having a strong peak intensity.

### DESCRIPTION OF THE PREFERRED EMBODIMENTS

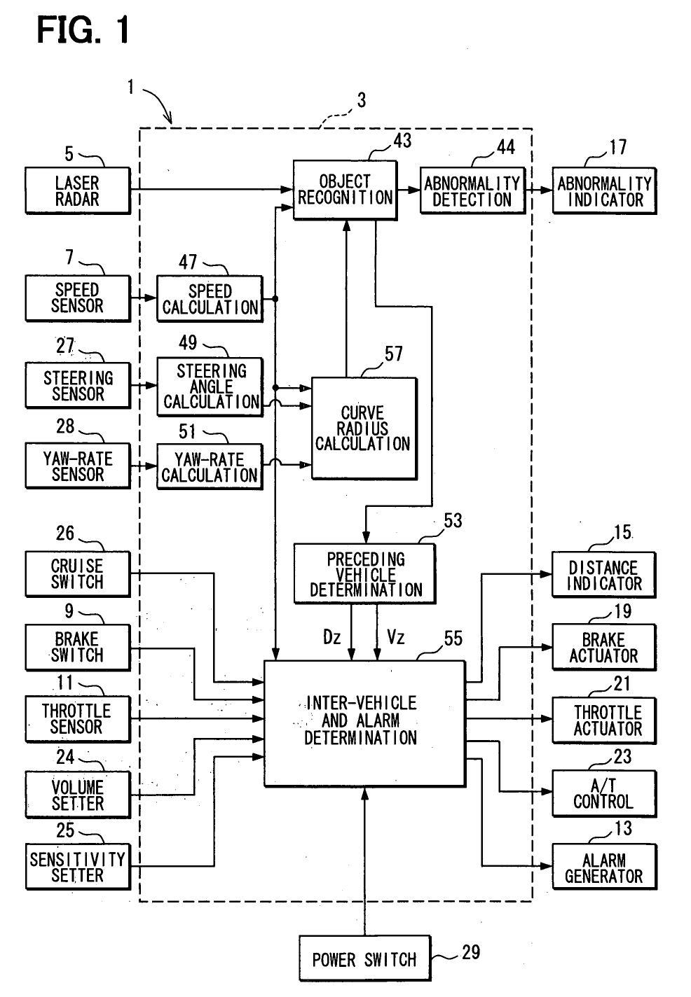

Referring first to FIG. 1, a vehicle radar device is applied to a vehicle control device 1 which produces an alarm when there is an obstacle in a region of shorter than a predetermined distance based on a result detected by the vehicle radar device, and controls the vehicle speed to maintain a predetermined distance relative to the preceding vehicle.

The vehicle control device 1 includes a recognition/inter-vehicle distance control ECU 3. The distance control ECU 3 includes a microcomputer, and includes an input/output interface (I/O), various drive circuits and detector circuits. These hardware construction is known and hence not described here in detail.

The distance control ECU 3 receives detection signals from a laser radar sensor 5 which is the vehicle radar device, a vehicle speed sensor 7, a brake switch 9 and a throttle position sensor 11, and sends drive signals to an alarm sound generator 13, a distance indicator 15, an abnormality indicator 17, a brake actuator 19, a throttle actuator 21 and to an automatic transmission controller 23.

To the distance control ECU 3, further, there are connected an alarm sound volume-setting unit 24 for setting the volume of alarm sound, an alarm sensitivity-setting unit 25 for setting the sensitivity in the alarm determination processing, a cruise control switch 26, a steering sensor 27 for detecting the amount of operating a steering wheel (not shown), and a yaw-rate sensor 28 for detecting the yaw-rate occurring in the vehicle. The distance control ECU 3 further includes a power source switch 29, and starts executing predetermined processing upon the turn-on of the power source switch 29.

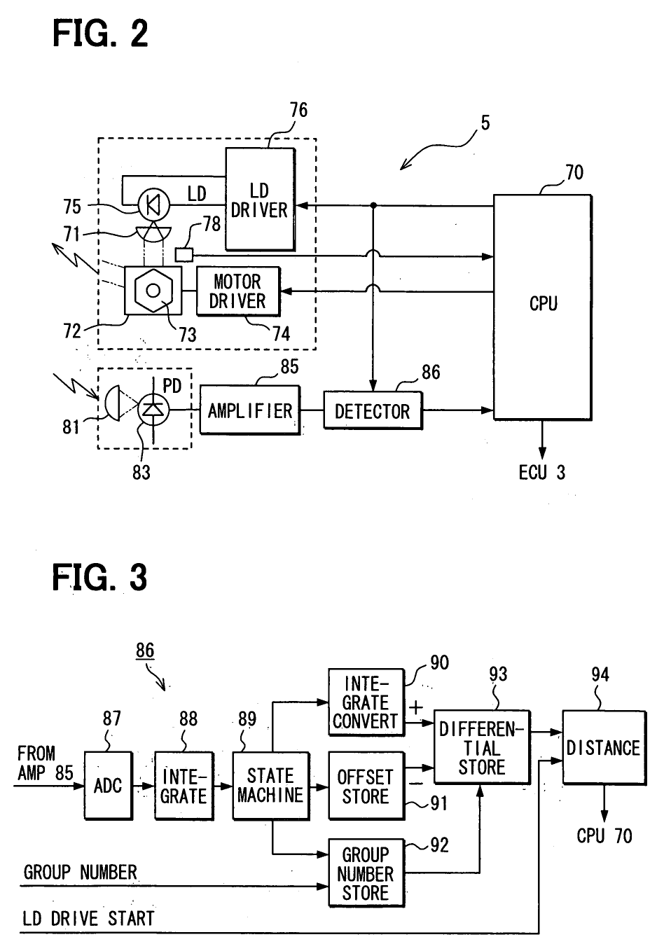

As shown in FIG. 2, the laser radar sensor 5 includes a light-emitting unit, a light-receiving unit, a laser radar CPU 70 and the like. The light-emitting unit includes a semiconductor laser diode 75 which radiates a pulse-like laser beam through a light-emitting lens 71 and a scanner 72. The laser diode 75 is connected to the laser radar CPU 70 through a laser diode driver circuit 76, and radiates (emits) a laser beam in response to a drive signal from the laser radar CPU 70. The scanner 72 includes a polygonal mirror 73 that rotates about a vertical axis. When the drive signal from the laser radar CPU 70 is input to a motor driver 74, the polygonal mirror 73 is rotated by the driving force of a motor (not shown). The rotational position of the motor is detected by a motor rotational position sensor 78, and is output to the laser radar CPU 70.

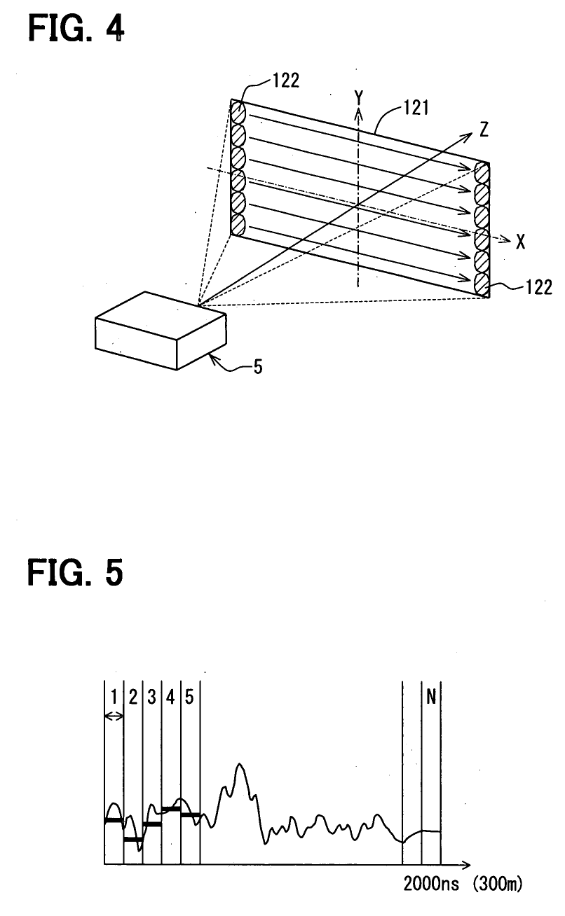

The polygonal mirror 73 has six mirrors with different plane tilting angles, and is capable of producing a laser beam so as to discretely scan over ranges of predetermined angles in the direction of vehicle width and in the direction of vehicle height. The laser beam is thus scanned in a two-dimensional manner. The scanning pattern will now be described with reference to FIG. 4 which illustrates a case where a laser beam pattern 122 is emitted to the right end and to the left end only within an area 121 for detecting a reflecting object. The patterns in the intermediate portions are omitted. In FIG. 4, the projected laser beam pattern 122 is nearly of an elliptic shape. Not being limited thereto, however, the projected laser beam pattern 122 may be of a rectangular shape or the like. In addition to using the laser beam, there can be further used electromagnetic waves such as millimeter waves or ultrasonic waves. Not being limited to the scanning system, further, there may be employed a system capable of measuring two azimuths in addition to the distance.

In FIG. 4, when the direction of radiation is Z-axis, the laser beam is so radiated as to successively scan within an XY plane perpendicular to the Z-axis. In this embodiment, the Y-axis which is the direction of height is referred to as the reference direction, and the X-axis which is the direction of vehicle width is referred to as the scanning direction. The laser beam is radiated for 327 points being shifted in the X-axis direction by a predetermined angle each time, and the radiation for 327 points in the X-axis direction is repeated in the Y-axis direction by an amount of 6 scanning lines. Therefore, a plurality of laser beams are radiated for each of the scanning lines from the first scanning line up to the sixth scanning line.

When the laser beam that is reflected is received upon radiating the laser beam onto the above detection area 121, the laser radar CPU 70 calculates scanning angles θx and θy representing angles of radiating the laser beams and a distance L that is measured, and outputs them to the distance control ECU 3. The two scanning angles θx and θy are such that the longitudinal scanning angle θy represents an angle between the Z-axis and a line along which the laser beam is projected onto the YZ plane, and the transverse scanning angle θx represents an angle between the Z-axis and a line along which the laser beam is projected onto the XZ plane.

As shown in FIG. 2, the light-receiving unit of the laser radar sensor 5 includes a focusing lens 81 for focusing the laser beam reflected by an object (not shown), and a light-receiving element (photodiode) 83 that produces a voltage signal (received light signal) corresponding to the intensity of the reflected light that is focused. The received light signal produced by the light-receiving element 83 is amplified through an amplifier 85, and is input to a detector circuit 86 that detects the reflecting object based upon the integrated signal obtained by integrating a predetermined number of received light signals. The configuration and operation of the detector circuit 86 will now be described.

Referring to FIG. 3, the detector circuit 86 includes an analog/digital converter (ADC) 87. The received light signals output from the amplifier 85 are input to the AD converter 87 and are converted into digital signals at a predetermined sampling frequency. The received light signals converted into digital signals are input to an integration processing unit 88 and are temporarily stored therein. The received light signals to be converted into digital signals are those signals that are output from the amplifier circuit 85 until a predetermined period of time (e.g., 2000 ns) elapses from the moment when the laser beam has been emitted. Referring to FIG. 5, the AD converter 87 divides the received light signals into N sections at a predetermined time interval (e.g., 25 nsec) and converts average values of the received light signals of these sections into digital values.

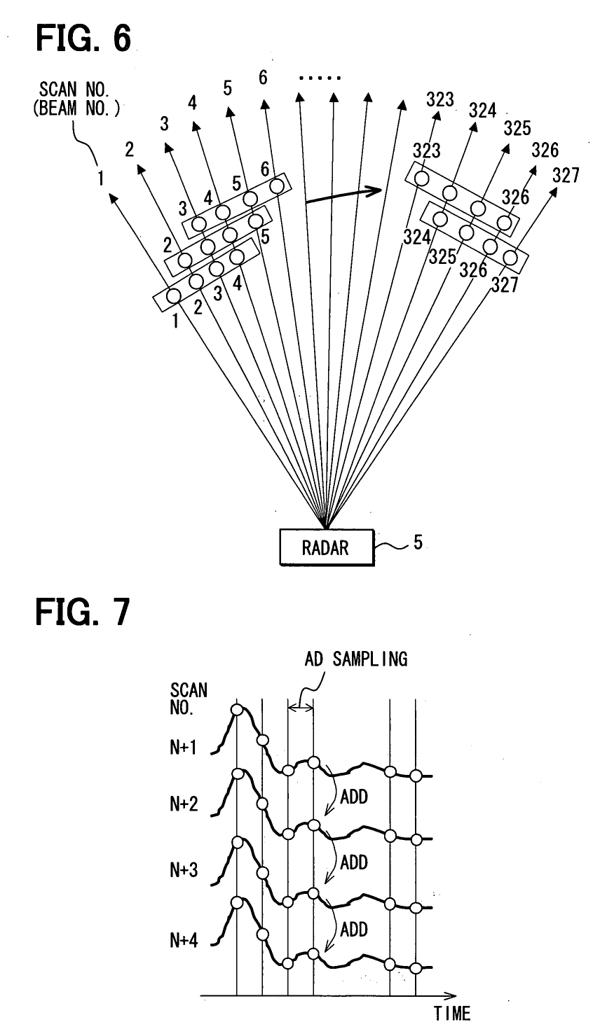

The integration processing unit 88 specifies, out of the received light signals that are temporarily stored, the received light signals of a predetermined number corresponding to the predetermined number of laser beams radiated neighboring each other in the direction of X-axis as a range of the received light signals to be integrated. The integration processing unit 88 calculates the integrated signal (integrated received light signal) of the received light signals belonging to the specified range. The range of the received light signals that are specified by, and are to be integrated by, the integration processing unit 88 and how to calculate the integrated signal, will now be described with reference to FIGS. 6 and 7.

FIG. 6 is a diagram schematically illustrating a range of the received signals that are to be integrated when the range of the received light signals to be integrated is set to 4 by imparting beam numbers (scan numbers for the received signals) for the laser beams radiated being shifted by a predetermined angular range in the detection region 121. For easy explanation, FIG. 6 shows a laser beam of one scanning line only.

It may be attempted to detect the preceding vehicle by using the vehicle radar device of this embodiment. In this case, the preceding vehicle has a reflector on the rear surface thereof to highly reflect the laser beam. The vehicle body, too, reflects the laser beam relatively highly though it is not as high as that of the reflector. Usually, therefore, the light reflected by the preceding vehicle is sufficiently intense, and it is possible to detect the preceding vehicle from the received light signals of single reflected light. However, when, for example, mud, snow and the like adheres to the rear surface of the preceding vehicle, the intensity of light reflected by the preceding vehicle drops. In this case, therefore, it becomes probable that the preceding vehicle cannot be detected based on the individual received light signals corresponding to light reflected by the preceding vehicle.

Therefore, a plurality of received light signals are integrated to amplify the received light signals which are reflected by the preceding vehicle to detect even the reflected waves having small intensities. The integration processing unit 88, first, specifies the received light signals that are to be integrated. That is, as shown in FIG. 6, the integration processing unit 88 specifies the received light signals of a predetermined number corresponding to the laser beams of a predetermined number neighboring on the same scanning line (same plane) to be the received light signals that are to be integrated. Specifically, the received light signals of scan numbers 1 to 4 are specified as a line 1. Next, the received light signal is deviated by one signal, and the received signals of scan numbers 2 to 5 are specified as a line 2. Hereinafter in the same manner, the received signals of the neighboring four laser beams are successively specified up to a line 324.

Thus, integrated signals obtained by integrating the received light signals belonging to the specified ranges are successively output in synchronism with specifying the range of the received light signals to be integrated. Referring to FIG. 7, the integration refers to a processing for adding up (integrating) all digital values obtained by AD-converting the four received light signals at the same time. The four received light signals to be integrated are indicated by a rectangle in FIG. 6. By integrating the predetermined number of the received light signals, the S/N ratio of the received light signals can be improved. The reason is as described below.

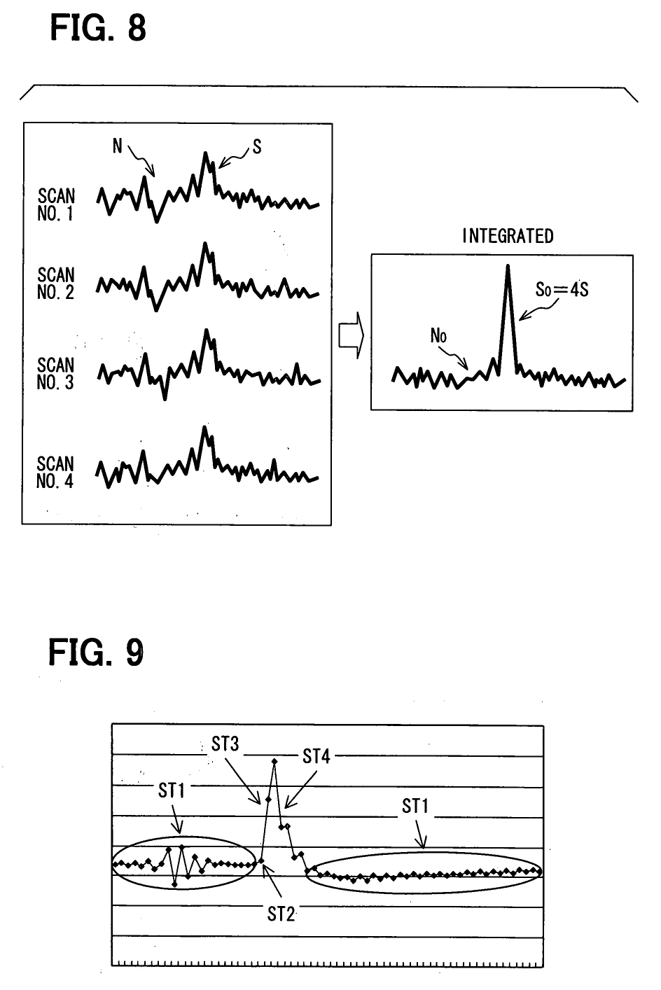

As shown in FIG. 8, when, for example, the four received light signals all contain a received light signal component S corresponding to a wave reflected by the same reflecting object, the received light signal component S appears at a moment after the elapse of the same time from when the laser beam is emitted. Therefore, the received signal component So in the integrated signal becomes equal to the received light signal component S in each received light signal that is amplified into four folds. On the other hand, the noise component N contained in each received light signal is basically generated in a random fashion due to external light. Even when the four received light signals are integrated, therefore, the amplified degree of the noise component No is smaller than the received light signal component S.

By calculating the integrated signal by the integration processing unit 88, therefore, it is possible to improve a ratio (S/N ratio) of the received light signal component So and the noise component No. As a result, even when the received light signal component S contained in each received light signal is so small that it cannot be easily distinguished from the noise component N, use of the above integrated signals makes it possible to detect the reflecting object based on the received light signal component So that is amplified.

As described above, further, the integrated processing unit 88 moves the range of the received light signals that are to be integrated by shifting the received light signals one by one. This minimizes a drop in the resolution of detection based on the integrated signals while integrating four received light signals. That is, if the signals to be integrated are calculated by simply grouping the received light signals output from the light-receiving element 83 in a number of 4, the sensitivity for detecting the reflected light can be improved but the resolution of detection by the integrated signals drops greatly. On the other hand, if the range of the received signals to be integrated is shifted by an amount of one received light signal each time, a drop in the resolution of detection can be suppressed.

In the description of using FIGS. 6 and 7, the range of the received light signals to be integrated is set to be 4 which, however, is conveniently determined for easy explanation. Namely, the range of the received light signals to be integrated, i.e., the number of the received light signals to be integrated can be set to be any value depending upon the size of the object to be detected, angle between the neighboring laser beams and a maximum distance of detection.

The integration processing unit 88 successively outputs the integrated signals obtained by integrating the received light signals belonging to each of the ranges of the received light signals to be integrated, i.e., successively outputs the integrated signals of each of the lines from the line 1 up to line (327−range of the received light signals to be integrated+1) while shifting the range of the received light signals to be integrated.

Referring to FIG. 3 again, a state machine unit 89 determines in which state of the waveform of the integrated signal, i.e., in which state of searching the peak ST1, rise start ST2, rising ST3, falling ST4 or rise check ST5, the points are present representing signal components of the integrated signals at regular intervals (sampling points of when the received light signals are put to the AD conversion at a predetermined sampling frequency, or point of results integrated by the integration processing unit 88, hereinafter referred to as points).

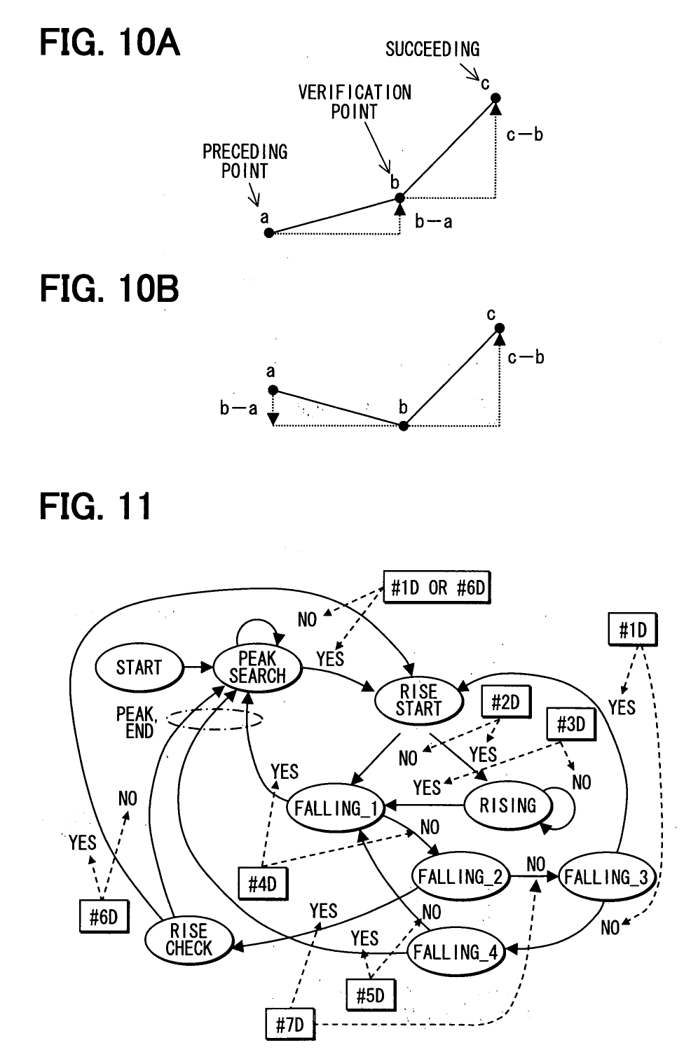

Referring to FIGS. 10A and 10B, one point (verification point) is determined by using two points preceding and succeeding (following) the above point in time, i.e., by using a point preceding the verification point and a point succeeding the verification point. In FIGS. 10A and 10B, “a”, “b” and “c” are the integrated results of the received signals (magnitudes of the integrated signal components) at each of the points. Differences are calculated among the verification point, the preceding point and the succeeding point (“b−a” and “c−b”), and in which one of the states shown in FIG. 9 the point is present is determined from the signs of differences and the magnitudes (gradients) of the differences.

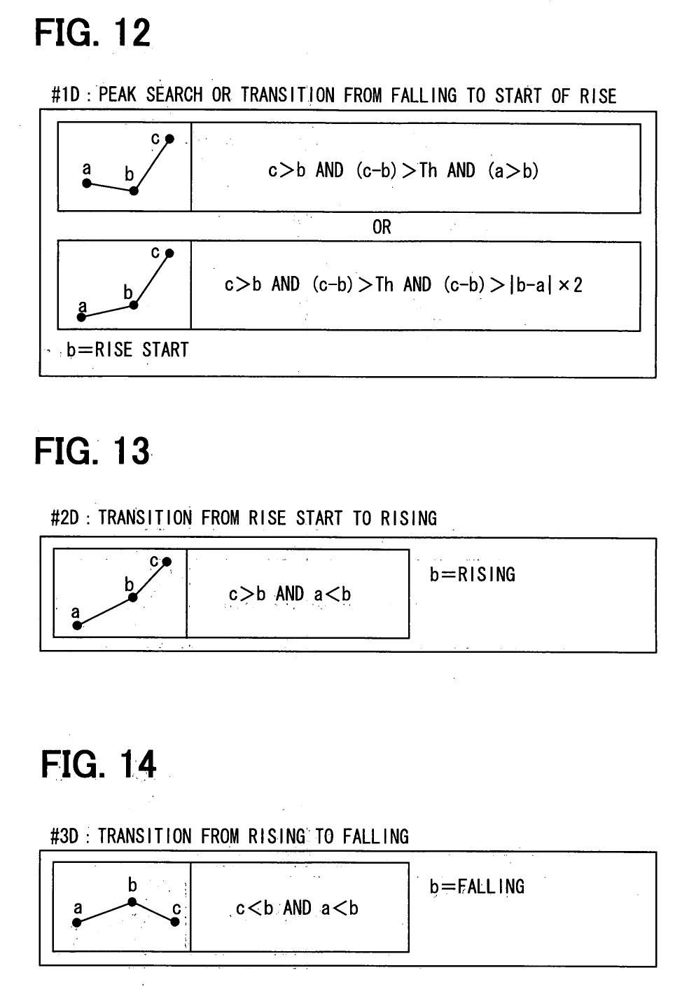

The state machine unit 89 determines the state of the verification point along a state transition diagram of FIG. 11. Determining the state of the verification point starts with the “start” in FIG. 11. After having entered the “start” state, the determination is unconditionally shifted to the “peak search” state. When shifted to the “peak search” state, it is checked if the condition is holding (YES) for the first determination (#1D) shown in FIG. 12 or for the sixth determination (#6D) shown in FIG. 17 from the signs of the verification point and the preceding and succeeding points thereof and from the gradients thereof. The first determination and the sixth determination are the conditions for determining the rise of the peak waveform. The verification point holding the condition for the first determination or the sixth determination is determined to be a point in the “rise start” state (first case).

When the condition for the first determination or the sixth determination does not hold (NO), the verification point is determined to be in the “peak search” state and is shifted to a next verification point to repeat the same determination. The “rise start” state literally represents a point at a moment when the peak waveform starts rising to represent the reception of the wave reflected by the reflecting object. The first determination shown in FIG. 12 is a determination of when the integrated signal component has a large peak. The determination is rendered to be “rise start” when either one of the following two conditions holds.

(first determination #1D)

Condition 1: (c>b) AND [(c−b)>Th (threshold value)] AND (a>b)

Condition 2: (c>b) AND [(c−b)>Th] AND [(c−b)>(|b−a|×2)]

Further, the sixth determination shown in FIG. 17 is a determination of when the integrated signal component has a small peak. Like the First determination, the determination is rendered to be “rise start” when either one of the following two conditions holds.

(sixth determination #6D)

Condition 1: (c>b) AND [(c−b)>Th/4] AND [(c−b)>(|b−a|×3)]

Condition 2: (c>b) AND (b>a) AND [(c−b)+(b−a)>(Th×0.625)]

Here, in the diagram of state transition of FIG. 11, when the following five particular state transition paths are followed after determined to be in the “rise start” state, it is so determined that a point series consisting of a plurality of points following the state transition is a group forming a peak waveform that represents the reception of the waves reflected by the reflecting object. The following state transitions (a) to (e) are not representing all of the states in the transition steps but describe only three states; i.e., “Initial state”→“Last state”→“State next of last state”, and the transition steps on the way are omitted. Like the case of waveforms having two peaks attached thereto, the number of the groups forming peak waveforms is not limited to one.
(a) “Rise start”→“Falling_{—}1”→“Peak search”
(b) “Rise start”→“Falling_{—}4”→“Peak search”
(c) “Rise start”→“Rise check”→“Peak search”
(d) “Rise start”→“Rise check”→“Rise start”
(e) “Rise start”→“Rising_{—}3”→“Rise start”

In the case of a peak waveform of a general shape shown in FIG. 9, it will be learned that the points forming the peak waveform follow a particular state transition like “Rise start ST2”→“Rising ST3”→“Falling ST4”→“Peak search ST1”.

By giving attention to the fact that a plurality of points which are continuing in time and are forming a peak waveform, follow a particular state transition, the state machine unit 89 determines in which state of “peak search”, “rise start”, “rising”, “falling”or “rise check”, the verification point is present from the signs of differences in the signal components among the verification point and at least two points preceding and succeeding the verification point in time and from the magnitudes of the differences.

Therefore, if a plurality of points continuing in time follow a particular state transition like, for example, “Rise start ST2”→“Rising ST3”→“Falling ST4”→“Peak search ST1”, a point series consisting of the plurality of points is determined to be a group forming the peak waveform.

When the state machine unit 89 finishes the determination of state transition for all points, a received signal integration converter unit 90 stores the integrated signals of a point series belonging to a group that forms a peak waveform that follows any one of the above five state transitions (a) to (e), and executes a processing for changing (converting) the magnitudes of the signal components to “0” (zero) for the points that do not belong to the group for forming the peak waveform. It is therefore made possible to pick up the integrated signals only of the point series belong to the group forming the peak waveform out of the integrated signals output from the integration processing unit 88.

Next, described below is how to determine the state of points by the state machine unit 89 after the point is determined to be in the “rise start” state (after the case 1). In FIG. 11, a second determination #2D shown in FIG. 13 is executed for a point (next point) next of the point that has shifted to the “rise start” state in FIG. 11. The second determination shown in FIG. 13 is a determination of when the integrated signal component has a large peak. When the following condition holds, the verification point is determined to be a point in the “rising” state (case 2).

(second determination #2D)

Condition: (c>b) AND (a<b)

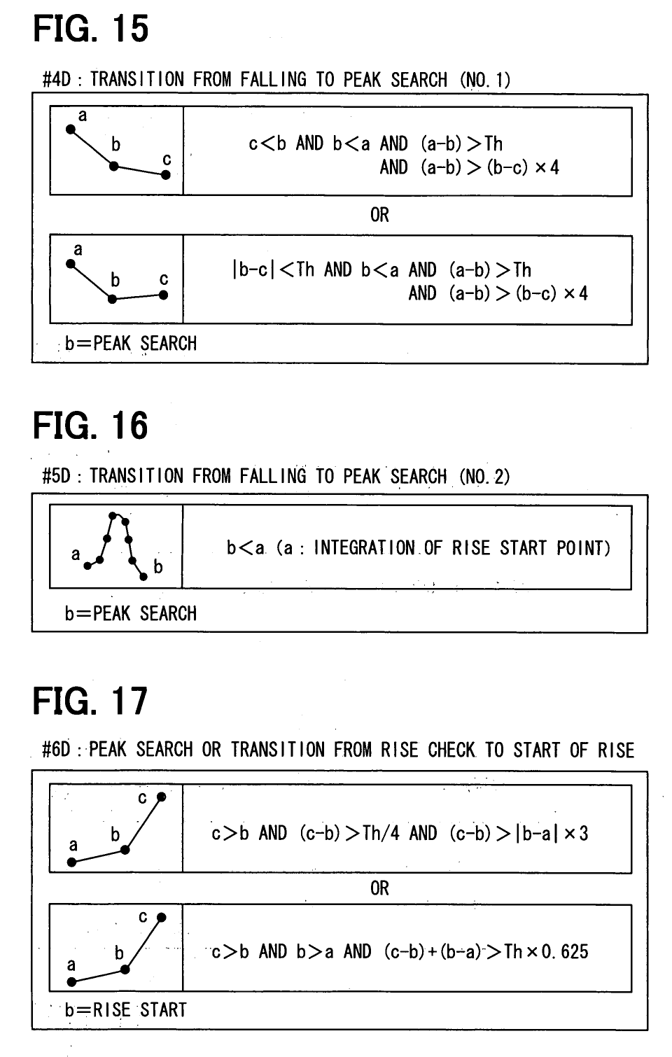

When the condition of the second determination does not hold, i.e., when the state is not “rising”, the verification point shifts to the “falling_{—}1” state. When shifted to the “falling_{—}1” state, a fourth determination (#4D) shown in FIG. 15 is executed for the same verification point. The fourth determination shown in FIG. 15 is the determination of when the integrated signal component exhibits a large peak. When either one of the following two conditions holds, the verification point is determined to be a point in the “peak search” state, and the point is returned to the “peak search” state. This is a case where only one point is in the peak state (triangular state)(case 3).

(fourth determination #4D)

Condition 1: (c<b) AND (b<a) AND (a−b)>Th AND
(a−b)>(b−c)×4

Condition 2: |b−c|<Th AND b<a AND (a−b)>Th AND
(a−b)>(b−c)×4

The state transition described above is the state transition of (a) “Rise start”→“Falling_{—}1”→“Peak search”.

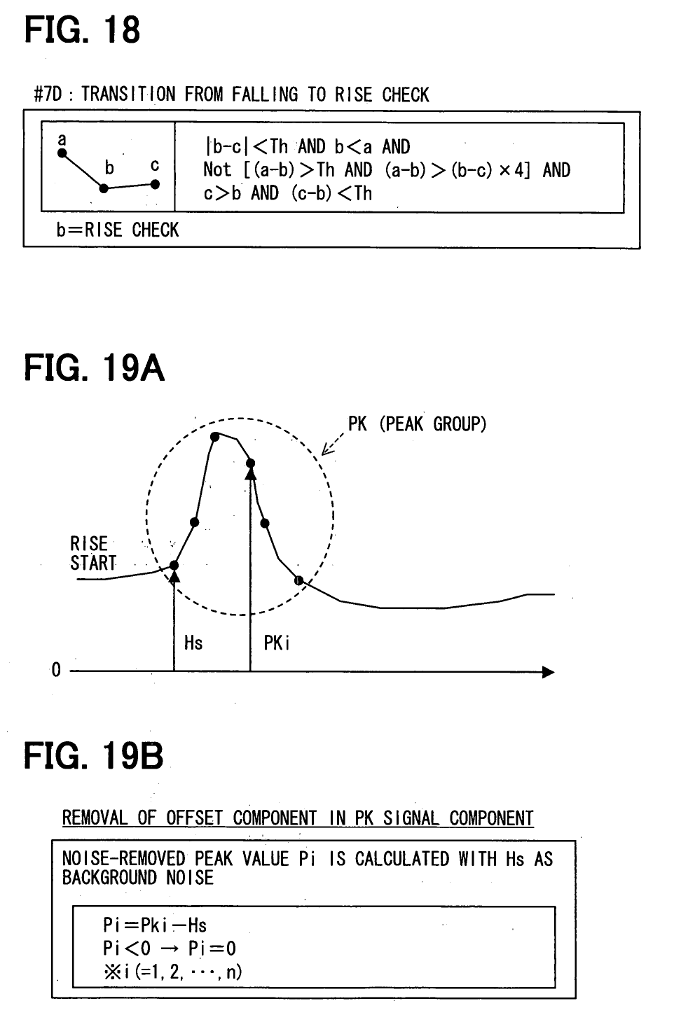

Next, when the condition of the fourth determination does not hold after having shifted to the state of “Falling_{—}1”, the verification point shifts to the state of “Falling_{—}2”. A seventh determination #7D shown in FIG. 18 is executed for the above verification point to check if the state is still falling or rising (case 4).

The seventh determination shown in FIG. 18 is the determination of when the integrated signal component exhibits a small peak. When the following condition holds, it is so determined that the “falling state” is shifting to a mildly “rising state”, and the next point is determined to be the point in the “rise check” state.

(seventh determination #7D)

Condition: |b−c|<Th AND (b<a) AND
not [(a−b)>Th AND (a−b)>(b−c)×4] AND
c>b AND (c−b)<Th

A sixth determination #6D shown in FIG. 17 is executed for a point next of the verification point that is determined to be in the “rise check” state. When the condition of the sixth determination holds, the point shifts to the “rise start” state. When the condition thereof does not hold, the point returns to the “peak search” state. The state transition described above is the state transition of (c) “Rise start”→“Rise check”→“Peak search”.

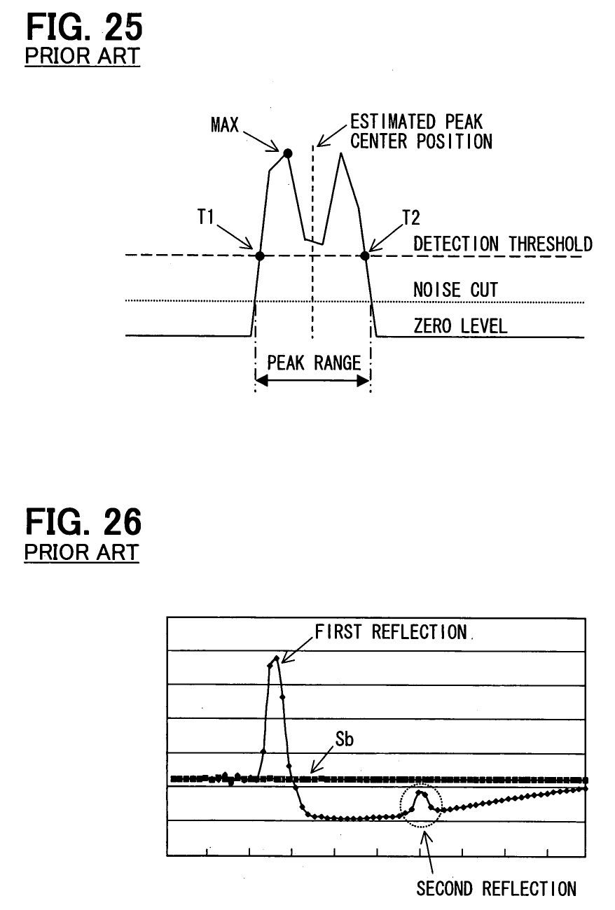

Here, the state transition from the “rise check” state to the “rise start” state represents as shown in FIG. 25 that the state forming a valley after the end of the preceding peak in the synthesized waveform of two peaks is shifting to a state where the next peak is in the “rise start” state. That is, the state transition is a transition for determining the separation of a peak waveform having two peaks attached thereto, and is the state transition of (d) “Rise start” →“Rise check”→“Rise start”.

Next, the description returns to when the point is determined to be in the “rising” state of the above-mentioned “case 2”. Here, a third determination #3D shown in FIG. 14 is executed for the next point to determine the shift from the “rising” state to the “falling” state. The third determination shown in FIG. 14 is the determination of when the integrated signal component exhibits a large peak. When the following condition holds, the verification point is determined to be the point in the “falling” state. When the condition of the third determination does not hold, this point, too, becomes in the “rising” state, and the third determination is similarly executed for the next point to repeat the falling determination.

(third determination #3D)

Condition: (c<b) AND (a<b)

When the condition of the third determination holds in the “rising” state of the “case 2”, the next point shifts to the “falling_{—}1” state. The point that has shifted to the “falling_{—}1” state represents the state transition same as those described in the “case 3” and in the “case 4”.

Next, when the seventh determination does not hold in the “case 4”, the verification point is just shifted to the “falling_{—}3” state. After the shift, the first determination is executed for the same verification point. When the condition of the first determination holds, a point next of this point is regarded to be in the “rise start” state. Here, too, the state transition is exhibited from the state forming a valley after the end of the preceding peak in the synthesized waveform of a plurality of peaks to the “rise start” state of the next peak.

In this case, separation of the peak is determined like the state transition in the case of (d). In the case of (d), the falling state of the preceding peak gradually comes to a halt and the next peak is going to rise. In this case, however, the next peak suddenly starts rising while the preceding peak is falling, making a difference. The above state transition it the state transition of (e) “Rise start”→“Rising_{—}3”→“Rise start”.

When the first determination does not hold at a point in the “falling_{—}3” state, the point readily shifts to the “falling_{—}4” state. Thereafter, a fifth determination #5D shown in FIG. 16 is executed for the above point to search a falling end point. The fifth determination shown in FIG. 16 is the determination of when the integrated signal component exhibits a large peak. When the following condition holds, the point is determined to be the point in the “peak search” state. The condition a of the fifth determination is the result of integrating the rise start points.

(fifth determination #5D)

Condition: (b<a)

When the condition of the fifth determination holds, the peak ends at a point which precedes the point, and the point is returned to the “peak search” state to determine the state for picking up a next new peak. The above state transition is the state transition of (b) “Rise start”→“Falling_{—}4”→“Peak search”. When the fifth determination does not hold, the next point is shifted to “falling 1” to repeat the shift of state transition.

In the foregoing was described the processing for determining the state by the state machine unit 89. Here, however, the state transition diagram shown in FIG. 11 is an example of picking up peak waveforms, and the invention is in no way limited to the method of picking up peak waveforms according to the above state transition diagram only. Further, the conditional formulas of the determinations shown in FIGS. 12 to 18 are some of the examples, and the invention is not limited to the above conditional formulas only.

The conditional formulas of the determinations shown in FIGS. 12 to 18 render the determination based on a relationship of the verification point which is a point to be determined and points which are preceding and succeeding the above point. Not being limited to the preceding point and the succeeding point, however, relationships covering points over more wide ranges may be used for rendering the determination.

The offset storing unit 91 shown in FIG. 3 stores, as an offset component, a signal component of a point determined to be in the “rise start” state in a point series (point series belonging to a group forming a peak waveform) that follows any one of the above state transitions (a) to (e) determined by the state machine unit 89.

In the case of a group (peak group PK) forming a peak waveform as shown, for example, in FIG. 19A, a signal component (result of integrating the received signals) Hs of a point in the “rise start” state in the peak group PK is stored as an offset component. When there is a plurality of peak groups PK, the offset components are stored for each of the peak groups PK. The offset component represents an intensity close to the background noise in the prior art.

A differential processing storing unit 93 removes the offset component stored in the offset storing unit 91 from the integrated signal component of a point series belonging to the peak group PK stored in the received signal integration/conversion unit 90. That is, as shown in FIGS. 19A and 19B, a peak value after the noise is removed (noise-free peak value i) is calculated by subtracting the offset component Hs from the integrated signal component PKi of the point belonging to the peak group PK. When the noise-free peak value i is a negative value (i<0) as shown in FIG. 19B, the noise-free peak value i is set to be “0” (zero).

By removing the offset components from the integrated signal components PKi of points belonging to the peak group PK as described above, it is allowed to remove the noise components superposed on the integrated signal components of the point series belong to the peak group PK without the need of measuring the background noise unlike that of the prior art.

When there are a plurality of peak groups PK as a result of determination by the state machine unit 89, a group number storing unit 92 imparts group numbers to all points belonging to the peak groups PK to distinguish the peak groups PK, and stores the integrated signals of point series belonging to the peak groups PK in relation to the group numbers.

When there is only one peak group PK, it can be easily learned from the integrated signal from which the offset component is removed by the differential processing/storing unit 93 that a point having a signal component which is not zero is the point belonging to the peak group PK. When there is a plurality of peak groups PK and, particularly, when two peaks are attached thereto, however, the boundary in the peak waveform becomes obscure in the integrated signal from which the offset component is removed by the differential processing/storing unit 93.

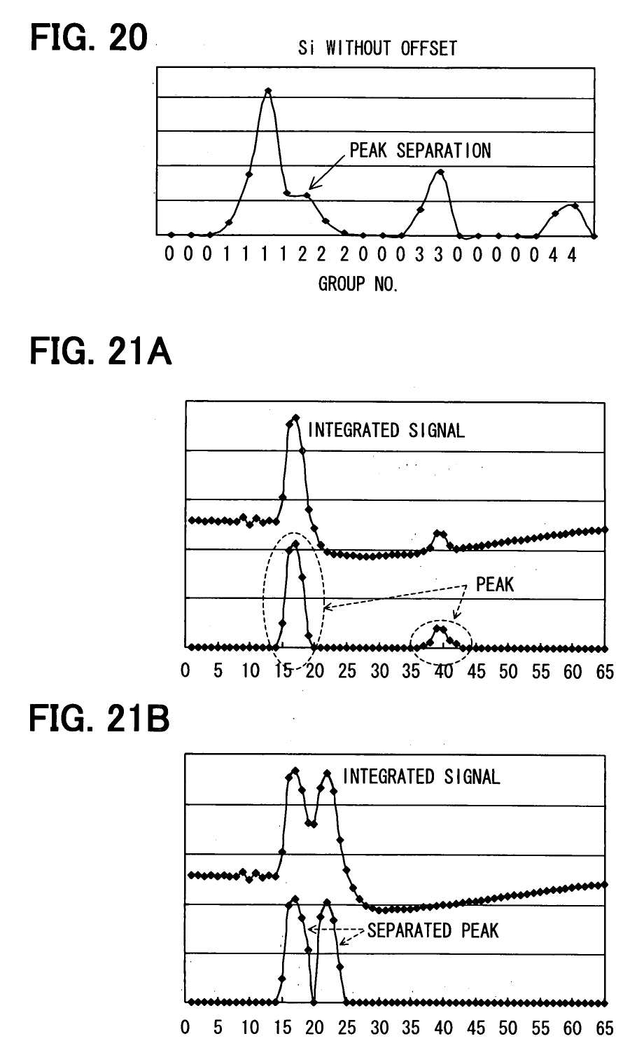

In the case of a waveform synthesizing two peaks as shown in, for example, FIG. 20, data is necessary for clarifying a peak separation point (=boundary of peaks). As shown in FIG. 20, therefore, the group number storing unit 92 imparts the group numbers to all points belonging to the peak groups PK to distinguish the peak groups PK in a manner that the group numbers are the same in each peak group PK. Even when a plurality of peaks is attached, therefore, the boundary becomes clear in each peak waveform, and the peak waveforms can be distinguished.

As shown in FIG. 20, further, the peak groups PK and the group numbers imparted to the points belonging to the peak groups PK are corresponding in a manner of one to one. In FIG. 20, further, the points having a group number “0” (zero) are the points that are not picked up as the peak group PK, and the signal components of these points have been set to be zero at all times by the received signal integration/conversion unit 90.

The points of group numbers other than “0” (zero) are the points picked up as a peak group PK. For example, the four points having the group number “1” are the points belonging to the same peak group PK. The group number “1” is followed by three points having the group number “2” without holding the group number “0” therebetween. This indicates that the two peaks having the group number “1” and the group number “2” had been attached to each other, and were separated apart into two peaks with the peak separation point as a boundary.

The differential processing/storing unit 93 removes the offset component stored in the offset storing unit 91 from the integrated signal component of the point series belonging to the peak group PK stored in the received signal integration/conversion unit 90, imparts a group number to the integrated signal after the offset has been removed for each of the peak groups PK and stores them.

As shown in FIG. 21A, therefore, the peak waveform can be picked up from the integrated signal output from the integration processing unit 88. Even with the integrated signal having two peaks attached thereto as shown in FIG. 21B, the peak waveforms can be picked up from the two peaks by making a reference to the group numbers imparted to each of the peak groups PK.

A distance calculation unit 94 specifies a group number of a peak group that is to be picked up, and picks up an integrated signal from which the offset has been removed, that is in agreement with the specified group number from the integrated signals from which the offset has been removed and to which the group numbers have been imparted being stored in the differential processing/storing unit 93. The distance to the reflecting object is calculated from the time until the center of peak waveform of the integrated signal that is picked up is estimated from when the light is emitted. The calculated distance up to the reflecting body is output to the laser radar CPU 70.

Therefore, when it is desired to pick up only an integration signal after the offset has been removed to which, for example, a group number “1” has been imparted, the group number “1” is specified to pick up only the integrated signal from which the offset has been removed and to which the group number “1” has been imparted. Further, the distances can be calculated from the respective peaks by respectively picking up the peaks for the rest of all group numbers.

The laser radar CPU 70 forms position data based on the distance to the reflecting object input from the distance calculation unit 94 and on the scanning angles θx and θy of the corresponding laser beams. Specifically, from the distance and the scanning angles θx and θy, the position data of the reflecting object are calculated on the XYZ rectangular coordinate system with the center of laser radar as an origin (0, 0, 0), the direction of vehicle width as X-axis, the direction of car height as Y-axis, and the direction toward the front of the vehicle as Z-axis. The position data in the XYZ rectangular coordinate system are output as distance data to the distance control ECU 3.

When the distance to the reflecting object is to be calculated based on the integrated signal, the scanning angle θx of the laser beam corresponding to the integrated signal is the scanning angle θx of the laser beam at the central position among the plurality of laser beams corresponding to the plurality of integrated received light signals.

The distance control ECU 3 executes inter-vehicle distance control by recognizing the object based on the distance data from the laser radar sensor 5, and by controlling the vehicle speed by sending drive signals to the brake actuator 19, throttle actuator 21 and automatic transmission control unit 23 to meet the conditions of the preceding vehicle obtained from the recognized object. An alarm determining processing is also executed to produce an alarm in case the recognized object is staying in a predetermined alarm region for a predetermined period of time. The object in this case may be a vehicle travelling in front or a vehicle that is at rest ahead.

The distance ECU 3 will now be briefly described. The distance data output from the laser radar sensor 5 are sent to an object recognition block 43. Based on the three-dimensional position data obtained as the distance data, the object recognition block 43 calculates a central position (X, Y, Z) of the object, and a size (W, D, H) of the object such as width W, depth D and height H. Based on a change in the central position (X, Y, Z) with the passage of time, further, a relative speed (Vx, Vy, Vz) of the object is calculated with the position of the subject (own) vehicle as a reference. The object recognition block 43 further discriminates whether the object is at rest or is moving relying upon the vehicle speed (speed of the subject vehicle) output from the vehicle speed calculation block 47 based on the value detected by the vehicle sensor 7 and upon the relative speed (Vx, Vy, Vz) calculated above. Based on the result of discrimination and the central position of the object, objects are selected that affect the traveling of the subject vehicle, and the distances are displayed on the distance display unit 15.

Further, based on a signal from the steering sensor 27, a steering angle calculation block 49 calculates a steering angle and based upon a signal from the yaw-rate sensor 28, a yaw-rate calculation block 51 calculates a yaw-rate. Further, a curve radius (radius of curvature) calculation block 57 calculates a radius of curve (radius of curvature) R based on the vehicle speed from the vehicle speed operation block 47, steering angle from the steering angle calculation block 49 and yaw-rate from the yaw-rate calculation block 51. Based on the curve radius R, central position coordinate (X, Z), etc., the object recognition block 43 determines the probability in that the object is a vehicle and the probability in that the object is traveling in the same lane as the subject vehicle. An abnormal sensor detector block 44 detects any abnormal value of data calculated by the object recognition block 43. When the data have abnormal values, this fact is displayed on the abnormality indicator unit 17.

A block 53 for determining a preceding vehicle selects the preceding vehicle based on a variety of data obtained from the object recognition block 43, and calculates a distance Z to the preceding vehicle in the direction of Z-axis and a relative speed Vz. Then, a block 55 for controlling the inter-vehicle distance and for determining the alarm, determines whether an alarm be produced when it is the alarm determination or determines the content of vehicle speed control when it is the cruise determination, based on the distance Z to the preceding vehicle, relative speed Vz, preset state of the cruise control switch 26, state in which the brake switch 9 is depressed, position from the throttle position sensor 11 and a sensitivity setpoint by the alarm sensitivity setting unit 25. When the alarm must be produced, an alarm generating signal is output to the alarm sound generator 13. When it is the cruise determination, control signals are sent to the automatic transmission control unit 23, to the brake actuator 19 and to the throttle actuator 21 to effect the required control operations. When these control operations are executed, required display signals are output to the distance display unit 15 to notify the conditions to the driver.

According to the radar device 5 of this embodiment, the peak waveform is not picked up by subtracting the background noise as in the prior art. Instead, the shape of waveform of the integrated signal is determined to directly pick up the peak waveform. This suppresses the three problems ([Problem 1] the level of background noise fluctuates; [Problem 2]a peak waveform to which a plurality of peaks are attached is regarded to be a mass of peak waveform; [Problem 3] when the second signal reflected by another object is received just after the receipt of the first reflection signal having a high peak intensity, the peak waveform of the second reflected signal is not detected) which are inherent in the prior art. It is therefore made possible to suitably pick up the peak waves of the reflecting objects. The above embodiment may be modified as follows.

### (First Modification)

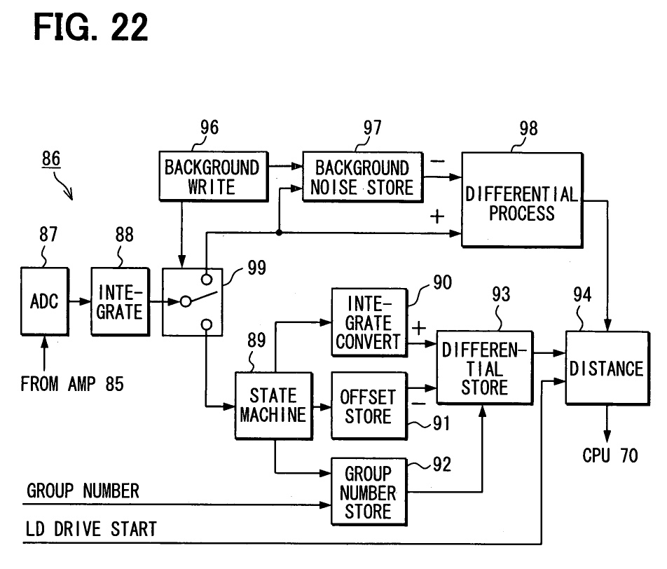

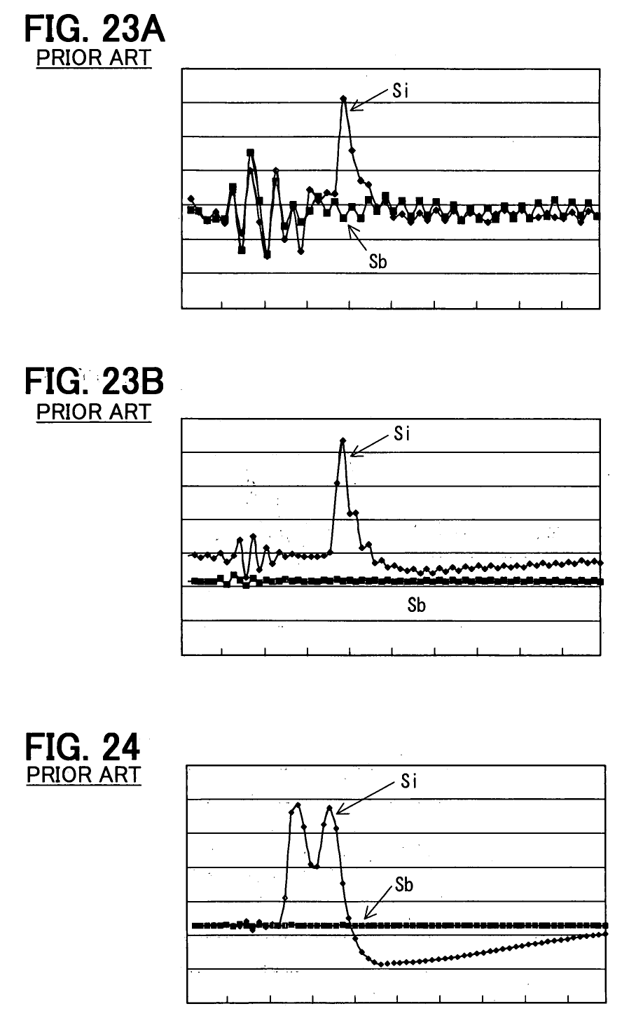

The method of picking up the peak waveforms of the above embodiment may be combined with a method of picking up the peak waveforms using background noise disclosed in US 2005/0200833. FIG. 22 shows a detector circuit 86 of this case.

A background write determining unit 96 of FIG. 22 is for determining that there is no reflecting object, and outputs the result of determination to a background noise storing unit 97 and to a processing switching unit 99. When the result of determination that there is no reflecting object is output from the background write determining unit 96, the processing switching unit 99 switches the connection to the upper side in the figure. Therefore, the integrated signal output from the integration processing unit 88 is output to the background noise storing unit 97 and to a differential processing unit 98.

The background noise storing unit 97 stores an integrated signal of when there is no reflecting object, which corresponds to background noise. The differential processing unit 98, executes the processing for removing the background noise stored in the background noise storing unit 97 from the integrated signal of when there is a reflecting object, and outputs the integrated signal from which the noise has been removed to the distance calculation unit 94.

When the result of determination that a reflecting object is present for a predetermined period of time is output from the background write determining unit 96 or when the user has instructed to return back to the embodiment of the invention by using a switch (not shown in FIG. 22), on the other hand, the processing switching unit 99 switches the connection to the lower side in the figure. Therefore, the processing described in the above embodiment is executed.

By employing the method of picking up the peak waveform of this embodiment in combination with the method of picking up the peak waveform using the background noise as described above, the method of picking up the peak waveform of this embodiment can be used as temporary means in a situation (traffic jamming) where the background noise cannot be measured.

### (Second Modification)

The above embodiment has dealt with an example of integrating the received light signals based on a plurality of laser beams radiated neighboring one another among the scanning lies scanned in the direction of X-axis. However, a predetermined number of received light signals may be integrated within a predetermined period of time, that are output based on the transmission waves radiated over a predetermined angle. In this case, too, the signal components corresponding to the waves reflected by the reflecting object are amplified. Here, however, random noise components that are superposed on the received light signals due to various factors are amplified to a small degree. Therefore, the integrated signals feature an improved S/N ratio of the received signal components to the waves reflected by the reflecting object.

### (Third Modification)

In the above embodiment, the integration processing unit 88 has shifted the range of the received light signals to be integrated by one received light signal each time. However, the range of the received light signals to be integrated may be shifted each time by a plurality of received signals which is not larger than the number of the received light signals to be integrated. In this case, too, the resolution for detecting the integrated signals can be improved as compared to when the received signals are, at least, grouped in a predetermined number to calculate an integrated signal therefrom.

### (Fourth Modification)

The above embodiment has dealt with an example of integrating the received light signals based on a plurality of laser beams radiated neighboring one another among the scanning lies scanned in the direction of X-axis. However, the received light signals to be integrated are not limited to those of the laser beams radiated neighboring one another in the X-axis direction but may be those of the laser beams radiated neighboring one another in the Y-axis direction. Further, the range of laser beams radiated neighboring one another may cover a plurality of scanning lines in the directions of X-axis and Y-axis.

### (Fifth Modification)

The above embodiment uses the polygonal mirror 73 having different plane tilting angles for two-dimensionally scanning the laser beams. However, this can similarly be realized even by using a galvano-mirror capable of effecting the scanning in the direction of the vehicle width and by using a mechanism capable of varying the tilting angle of the mirror surface. However, the polygonal mirror 73 offers an advantage of realizing the two-dimensional scanning by simply turning it.

### (Sixth Modification)

In the above embodiment, the distance and the corresponding scanning angles θx and θy are converted in the laser radar sensor 5 from the polar coordinate system into an XYZ rectangular coordinate system. However, the processing may be executed by the object recognition block 43.

### (Seventh Modification)

The above embodiment has employed the laser radar sensor 5 using a laser beam. However, it is also allowable to use electromagnetic waves such as millimeter waves or ultrasonic waves. However, there is no need to stick to the scanning system only, and there may be employed any system for measuring the azimuth in addition to the distance. When there is used, for example, an FMCW radar or a Doppler radar with millimeter waves, there are obtained the data of distance to the preceding vehicle and the data of relative speed of the preceding vehicle at one time from the reflected waves (received waves). Therefore, no step is necessary for calculating the relative speed based on the distance data, that is required when the laser beams are used.

### (Eighth Modification)

In the above embodiment, integrated signals are calculated by integrating a plurality of received light signals in order to detect even those reflecting objects that reflect the laser beam insufficiently. The reflecting objects, however, may be detected based upon the individual received light signals.

### (Ninth Modification)

The above embodiment has illustrated the case where the radar device was used as a radar device for a vehicle. However, the radar device is not limited for vehicle use only but can be used for detecting, for example, persons invading into predetermined areas.

### (Tenth Modification)

The above embodiment has illustrated an example of using the scanning system shown in FIG. 2. The invention, however, may similarly use a system which integrates the reflected signals within a predetermined period of time by fixing the laser beam in a specified direction (predetermined angle).

What is claimed is:

1. A radar device comprising:
radar means for radiating a plurality of transmission waves over a predetermined angular range and for producing received signals indicative of intensities of reflected waves, which correspond to the transmission waves;
state determining means for determining in which states of the waveforms of the received signals points are present, the points representing signal components at regular intervals of the received signals;
group determining means for determining a point series of a plurality of points that follow a predetermined state transition among the points determined by the state determining means to be a group that forms a peak waveform representing the reception of a wave reflected by a reflecting object;
pick-up means for picking up received signals of the point series belonging to the group that forms the peak waveform determined by the group determining means; and
detector means for detecting the reflecting object based on the received signals of the point series picked up by the pick-up means.

2. The radar device according to claim 1, wherein
the state determining means determines in which state of peak search, rise start, rising, falling or rise check, the point to be determined is present based on the point that is to be determined, upon signs of differences of signal components of at least two points preceding and succeeding in time the point and upon magnitudes of differences.

3. The radar device according to claim 1, further comprising:
processing means for storing the received signals of a point series belonging to the group that forms the peak waveform, and for executing processing for changing the magnitudes of signal components of points which do not belong to the group to be zero.

4. The radar device according to claim 1, further comprising:
offset storing means for storing, as an offset component, a signal component of a point that is determined by the state determining means to be in a rise start state in the point series belonging to the group that forms the peak waveform; and
offset removing means for removing the offset from the signal components of points belong to the group that forms the peak waveform.

5. The radar device according to claim 1, further comprising:
group data storing means which, when there are a plurality of groups forming the peak waveforms, imparts group data to all points belonging to the groups to distinguish the groups, and stores the received signals of the point series belonging to the groups in relation to the group data.

6. The radar device according to claim 5, wherein
the pick-up means includes group specifying means for specifying the group data imparted to the group that is to be picked up, and picks up received signals of the point series to which are imparted the group data that are in agreement with the group data specified by the group specifying means.

7. The radar device according to claim 1, further comprising:
integrating means for integrating a predetermined number of the received signals produced based upon a predetermined number of transmission waves radiated neighboring each other from the radar means, and for producing integrated signals thereof,
wherein the state determining means, the pickup means and the detector means use as the received signals the integrated signals produced by the integrating means.

8. The radar device according to claim 1, further comprising:
integrating means for integrating a predetermined number of the received signals within a predetermined period of time produced based on the transmission waves radiated by the radar means at a predetermined angle, and for producing the integrated signals thereof,
wherein the state determining means, the pickup means and the detector means use as the received signals the integrated signals produced by the integrating means.
